(19) United States
(12) Patent Application Publication
(10) Pub. No.: US 2015/0285434 A1
(43) Pub. Date: Oct. 8, 2015

(54) Ceiling Mounted Storage Device

(71) Applicant: Joseph Corrigan, Brigantine, NJ (US)

(72) Inventor: Joseph Corrigan, Brigantine, NJ (US)

(21) Appl. No.: 14/676,112

(22) Filed: Apr. 1, 2015

Related U.S. Application Data
(60) Provisional application No. 61/976,605, filed on Apr. 8, 2014.

(51) Int. Cl. F16M 13/02; B65D 25/24

(52) U.S. Cl. CPC F16M 13/027; B65D 25/24

(57) ABSTRACT

A ceiling mounted storage device that can be mounted substantially flush against a ceiling. The storage device includes a container having a base, one or more sidewalls, and an open upper end defining an interior volume in which objects can be stored. The container further includes one or more lips that extend inwardly from the upper end of the sidewalls, wherein the lip includes a plurality of slots therein. The storage device further comprises a bracket having a plurality of tabs that can be placed within the slots, whereby the container can be shifted to engage the tabs underneath the lip. The bracket further includes a plurality of apertures that allow screws or toggle bolts therethrough so the bracket can be attached to a ceiling. In this way, the storage container can be mounted flush against a ceiling, and preferably in the corner of a room.

### CROSS REFERENCE TO RELATED APPLICATION

This application claims the benefit of U.S. Provisional Application No. 61/976,605 filed on Apr. 8, 2014. The above identified patent application is herein incorporated by reference in its entirety to provide continuity of disclosure.

### BACKGROUND OF THE INVENTION

### Field of the Invention

The present invention relates to ceiling mounted storage devices. More specifically, the present invention provides a storage device that can be secured to a ceiling. The storage device includes a container and a bracket having a plurality of apertures adapted to receive a plurality of fasteners therethrough, such as screws or toggle bolts, wherein the fasteners secure the bracket to the ceiling. The container comprises one or more lips that extend inwardly and perpendicularly from the upper end of one or more sidewalls, wherein the lips include a plurality of slots therein. The bracket further includes a plurality of tabs that can be placed within the slots of the container, whereby the container can be shifted to engage the tabs underneath the lip. In this way, the container is removably fastened to the bracket. In an alternative embodiment, the base can be removably attached to the sidewalls, wherein one sidewall can be removably attached to another sidewall. Furthermore, the bracket can include one or more sides that can be removably attached together. In this way, the ceiling mounted storage device can be transported or stored in a compacted configuration, wherein the pieces of the container and bracket can be separated and stacked on top of one another.

Many residences lack sufficient storage space. As a result, people may pack their excess belongings behind or underneath furniture, on closet shelves, or in drawers. Such solutions create clutter and do not provide a person with easy access to their stored belongings. While various home organizing solutions are available, many of these devices consume substantial floor and closet space, and may not match the décor of the home or apartment in which the organizing device is situated. Additionally, many homes have empty or unused wall or ceiling spaces that would be well suited for additional storage if a storage device could be located in such areas. Thus, a storage device suited to be mounted on a ceiling and particularly in the corner of a room is provided.

Devices have been disclosed in the prior art that relate to ceiling mounted storage devices. These include devices that have been patented and published in patent application publications. These devices generally relate to storage containers that can be pivotally mounted to a ceiling or ceiling joists in basements or garages, wherein an individual can access stored objects by pulling one side of the crate down. Such devices include U.S. Published Patent Application Number 2010/0108627 to Lupinacci and Lupinacci, U.S. Pat. No. 5,725,293 to Wilkening et al., and U.S. Pat. No. 5,460,280 to Feddeler. These devices, however, fail to disclose a ceiling mounted storage device including a bracket that can be mounted to a ceiling, wherein the bracket engages with one or more lips on a storage container. Additionally, the devices in the prior art are not adapted to rest flush against a ceiling.

Other devices generally relate to mounting a storage container directly to ceiling joists or underneath a deck. Such devices include U.S. Published Patent Application 2008/0036341 to Nilson and Smith and U.S. Published Patent Application 2011/0030308 to Keenan. These devices, however, fail to disclose a ceiling mounted storage device including a bracket that can be mounted to a ceiling, wherein the bracket engages with one or more lips on a storage container. Additionally, the devices in the prior art are not adapted to rest flush against a ceiling.

In light of the devices disclosed in the prior art, it is submitted that the present invention substantially diverges in design elements from the prior art and consequently it is clear that there is a need in the art for an improvement to existing ceiling mounted storage devices. In this regard the instant invention substantially fulfills these needs.

### SUMMARY OF THE INVENTION

In view of the foregoing disadvantages inherent in the known types of ceiling mounted storage devices now present in the prior art, the present invention provides a new ceiling mounted storage device wherein the same can be utilized for providing convenience for the user when storing items in a container and mounting the container to a ceiling.

It is therefore an object of the present invention to provide a new and improved ceiling mounted storage device that has all of the advantages of the prior art and none of the disadvantages.

It is another object of the present invention to provide a ceiling mounted storage device comprising a container removably attached to a bracket, wherein the bracket is mounted to a ceiling, such that the container is substantially flush against the ceiling, thereby concealing the bracket and fasteners when attached thereto.

Another object of the present invention is to provide a ceiling mounted storage device wherein the container includes one or more lips extending inwardly and perpendicularly from the upper end of one or more sidewalls, wherein the lip comprises a plurality of slots and the bracket comprises a plurality of tabs that can be placed within the slots of the container, whereby the container can be shifted to engage the tabs underneath the lip.

Yet another object of the present invention is to provide a ceiling mounted storage device wherein the bracket includes a plurality of apertures adapted to receive fasteners therethrough so the device can be attached to a ceiling.

Another object of the present invention is to provide a ceiling mounted storage device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the ceiling mounted storage device.

FIG. 2 shows a perspective view of the bracket engaged with the container of the ceiling mounted storage device.

FIG. 3 shows a perspective view of the bracket of the ceiling mounted storage device.

FIG. 4 shows a perspective view of the bracket mounted to a ceiling.

FIG. 5 shows a cross sectional view of an embodiment of the ceiling mounted storage device.

FIG. 6 shows an exploded view of an alternative embodiment of the container and bracket of the ceiling mounted storage device.

FIG. 7 shows a perspective view of an embodiment of the ceiling mounted storage device in use.

### DETAILED DESCRIPTION OF THE INVENTION

Reference is made herein to the attached drawings. Like reference numerals are used throughout the drawings to depict like or similar elements of the ceiling mounted storage device. For the purposes of presenting a brief and clear description of the present invention, the preferred embodiment will be discussed as used for storing items in a container and mounting the container to a ceiling. The figures are intended for representative purposes only and should not be considered to be limiting in any respect.

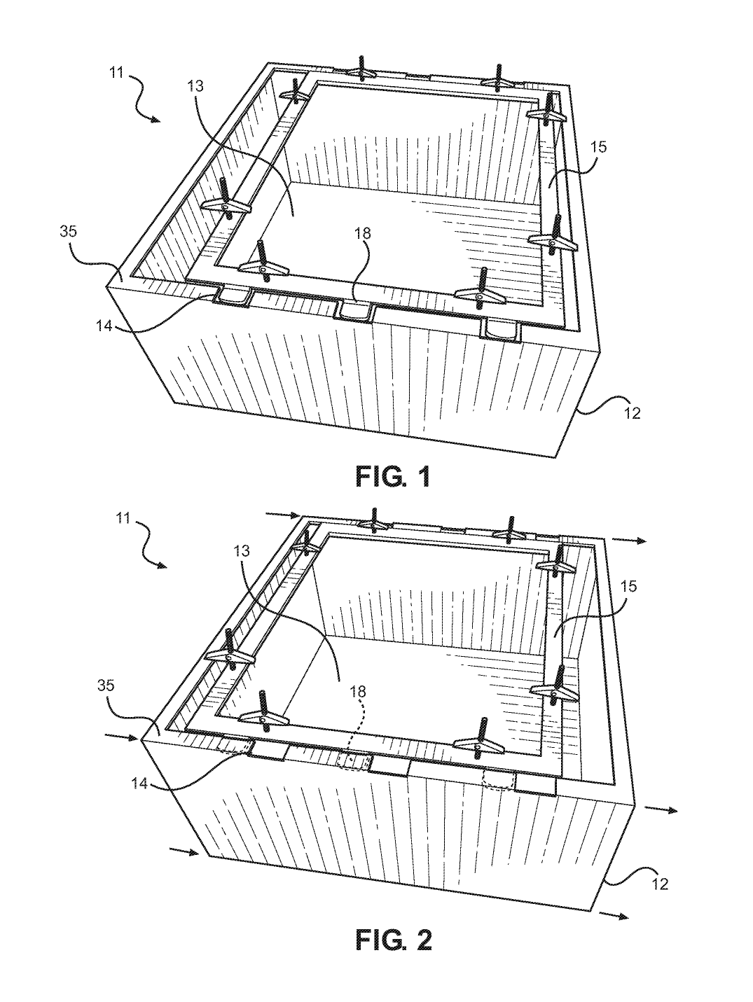

Referring now to FIGS. 1 and 2, there is shown a perspective view of an embodiment of the ceiling mounted storage device and a perspective view of the bracket engaged with the container of the ceiling mounted storage device. The storage device 11 comprises a container 12 removably securable to a bracket 15, wherein the bracket 15 is adapted to be permanently affixed to a ceiling. The container 12 includes a base 13, one or more sidewalls, and an open upper end, defining an interior volume in which objects can be stored. The container 12 further includes one or more lips 35 that extend inwardly and perpendicularly from the upper end of the sidewalls. A plurality of slots 14 are positioned in each lip 35. The slots 14 are parallel to the base 13 of the container 12 and are adapted to be placed over a plurality of tabs 18 disposed on the bracket 15, whereby the container can be shifted to engage the tabs underneath the lip 35. In this way, the container 12 can be removably attached to the bracket 15. The slots 14 are preferably spaced at fixed intervals, such that the slots 14 are aligned horizontally along the lip 35. Not all lips 35 must contain slots 14 therein. In the illustrated embodiment, slots 14 are disposed on opposing lips 35. In this way, the tabs 18 disposed on the bracket 15 are able to engage with the slots 14 and lip 35, as well as allow enough space for a user to mount the container 12 to a corner of the ceiling. The container 12 is preferably rectangular in configuration and composed of any suitable material such as wood, metal or plastic. In some embodiments, the container 12 further comprises one or more vertical dividers adapted to organize items therein.

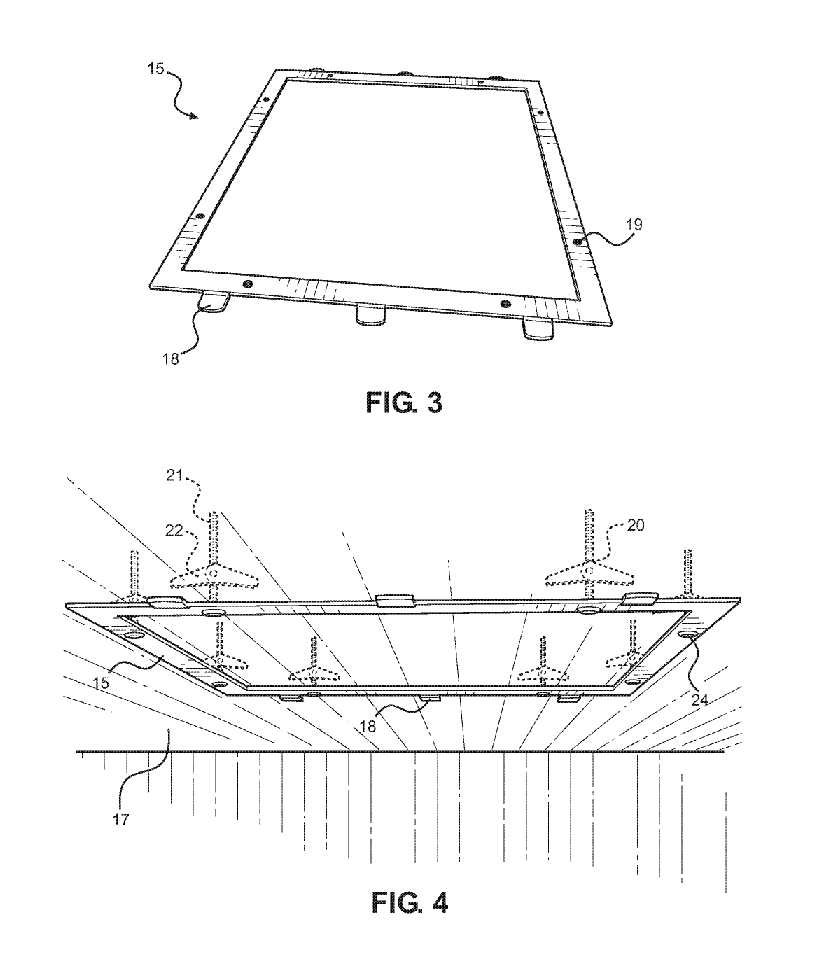

Referring now to FIGS. 3 and 4, there is shown a perspective view of the bracket of the ceiling mounted storage device and a perspective view of the bracket mounted to a ceiling. The bracket 15 includes one or more sides. The sides are substantially flat. In this way, the user is able to maximize the capacity of the container 12. The bracket 15 is substantially rectangular in configuration and composed of any suitable material, such as metal or plastic. In some embodiments, the bracket 15 can be configured in any way that corresponds to the configuration of the container 12 so the tabs 18 are able to engage with the corresponding slots 14.

The tabs 18 extend outwardly on the bracket 15. The tabs 18 are preferably spaced at fixed intervals, such that the tabs 18 are aligned horizontally along a side of the bracket 15. Not all sides of the bracket 15 must contain tabs 18 thereon. In the illustrated embodiment, tabs 18 are disposed on opposing sides of the bracket 15 adapted to fit within the corresponding slots positioned in the lips of the container. Preferably, the tab 18 and slot 14 will be substantially flat and rectangular in configuration. The dimension of the slot 14 is preferably larger than the dimension of the tab 18 so the tab can fit therein. Once the slot is placed over the tab, the container can be shifted so the tab is positioned underneath the lip. In this way, the tabs 18 can engage with the lip 35 so to allow the bracket 15 to removably attach to the container 12, thereby supporting the weight of the container 12 when the device 11 is attached to the ceiling.

The bracket 15 further includes a plurality of apertures 19 such that a plurality of fasteners can be threaded through the apertures 19, and permanently secured to a ceiling 17. The apertures 19 are preferably circular in configuration. In the illustrated embodiment, toggle bolts 20 are the preferred fastener because the device 11 can be attached directly to a hollow ceiling 17, without requiring ceiling joists or beams to support the weight of the device 11. Toggle bolts comprise a bolt 21 and a wing 22 adapted to fold during insertion into the ceiling and that springs open inside a hollow ceiling. In this way, the weight of the device 11 is spread over a larger area compared to a regular bolt. The bolt head 24 maintains the suspended position of the bracket 15. In some embodiments, the bracket can be mounted directly to a ceiling joist or beam, wherein any suitable fastener, such as a screw, can be used to attach the bracket to the ceiling.

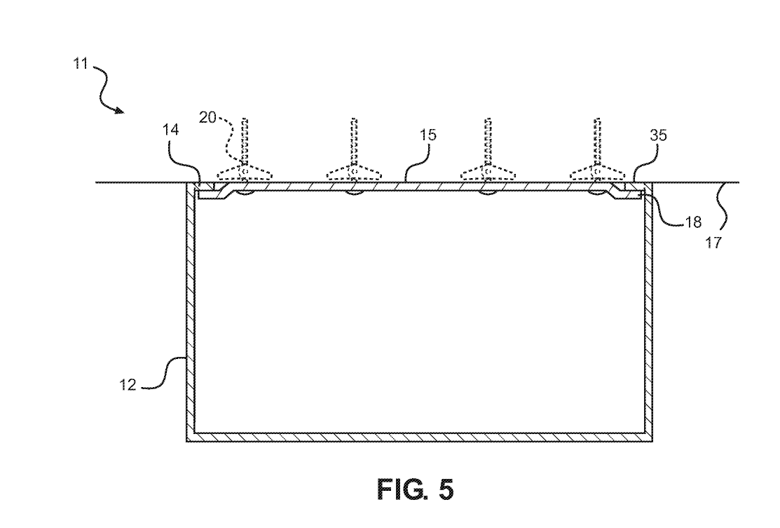

Referring now to FIG. 5, there is shown a cross sectional view of an embodiment of the ceiling mounted storage device. In operation, the bracket 15 can be secured to the ceiling 17 by threading the bolt 21 of the toggle bolt 20 through the aperture 19, wherein the wing 22 is then attached to the bolt 21 and subsequently springs open once inside the ceiling 17. The slots 14 of the container 12 can be placed over the tabs 18, whereby the container 12 can be shifted to engage the tabs 18 underneath the lip 35. Once the container 12 is mounted on the ceiling 17, the container 12 conceals the bracket 15 and the toggle bolts 20. The tabs 18 can be parallel to the ceiling 17 and the lips 35 and slots 14 can be flush against the ceiling 17. The tabs 18 are preferably lower than the sides of the bracket 15 to create a space between the tab 18 and the ceiling 17 so the lip 35 can fit therebetween.

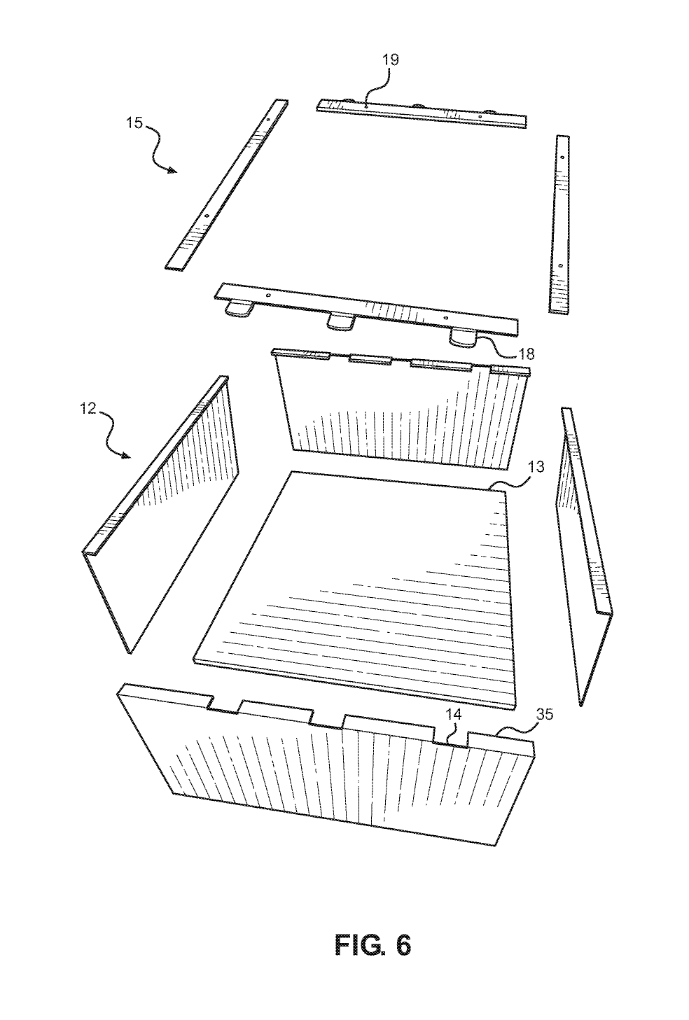

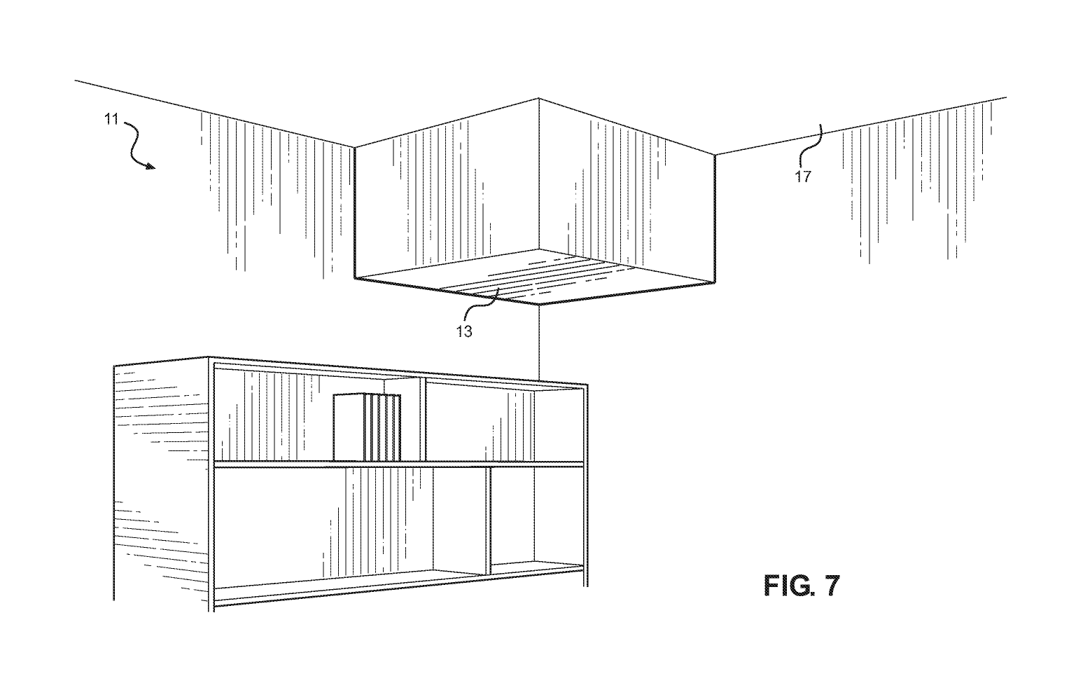

Referring now to FIG. 6, there is shown an exploded view of an alternative embodiment of the container and bracket of the ceiling mounted storage device. In an alternative embodiment, the base can be removably attached to the sidewalls, wherein one sidewall can be removably attached to another sidewall. Furthermore, the bracket can include one or more sides that can be removably attached together. In this way, the ceiling mounted storage device can be transported or stored in a compacted configuration, wherein the pieces of the container and bracket can be separated and stacked on top of one another. Any suitable fastener, such as clips or adhesive, can be used to removably attach the base and the sidewalls of the container, as well as removably attach the sides of the bracket.

Referring now to FIG. 7, there is shown a perspective view of an embodiment of the ceiling mounted storage device in use. The ceiling mounted storage device 11 can be secured to a ceiling 17 in a home or apartment. Preferably, the storage device 11 is mounted on the ceiling in a corner of a room as shown in FIG. 5. In this way, the storage device 11 is not prominently displayed, and is used to fill an otherwise unused portion of a room. In operation, a user fills the container with items to be stored and then secures the container to the ceiling for storage. The items can then be accessed by removing the container from the ceiling. The exterior surfaces of the container can be painted or styled so as to match the paint color on the walls of a room, or otherwise match the décor of a room.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A ceiling mounted storage device, comprising:
a container having a base, one or more sidewalls, and an open upper end, defining an interior volume;
a bracket removably attached to said container, wherein said bracket attaches said container to a ceiling, wherein said container rests substantially flush against said ceiling;
a plurality of fasteners adapted to permanently attach said bracket to said ceiling.

2) The ceiling mounted storage device of claim 1, wherein said container comprises one or more lips along an upper end of said one or more sidewalls.

3) The ceiling mounted storage device of claim 2, wherein said one or more lips include a plurality of slots and said bracket comprises a plurality of tabs, wherein said plurality of slots is placed over said plurality of tabs and said container is shifted to engage said plurality of tabs underneath said one or more lips.

4) The ceiling mounted storage device of claim 2, wherein said plurality of slots are spaced at fixed intervals.

5) The ceiling mounted storage device of claim 2, wherein said plurality of tabs are spaced at fixed intervals.

6) The ceiling mounted storage device of claim 2, wherein said lip is perpendicular to said one or more sidewalls.

7) The ceiling mounted storage device of claim 1, wherein said bracket includes a plurality of apertures adapted receive said plurality of fasteners therethrough.

8) The ceiling mounted storage device of claim 1, wherein said plurality of fasteners are toggle bolts.

9) The ceiling mounted storage device of claim 1, wherein said bracket is preferably substantially rectangular.

10) The ceiling mounted storage device of claim 1, wherein said container is preferably substantially rectangular.

11) A ceiling mounted storage device, comprising:
a container having a base, one or more sidewalls, and an open upper end, defining an interior volume;
a bracket removably attached to said container, wherein said bracket attaches said container to a ceiling, wherein said container rests substantially flush against said ceiling;
a plurality of fasteners adapted to permanently attach said bracket to said ceiling;
wherein said base includes one or more panels removably attached together;
wherein said base is removably attached to said one or more sidewalls;
wherein said one or more sidewalls are removably attached together;
wherein said bracket comprises one or more sides, wherein said one or more sides are removably attached together.

12) The ceiling mounted storage device of claim 11, wherein said container comprises one or more lips along an upper end of said one or more sidewalls.

13) The ceiling mounted storage device of claim 12, wherein said one or more lips include a plurality of slots and said bracket comprises a plurality of tabs, wherein said plurality of slots is placed over said plurality of tabs and said container is shifted to engage said plurality of tabs underneath said one or more lips.

14) The ceiling mounted storage device of claim 12, wherein said plurality of slots are spaced at fixed intervals.

15) The ceiling mounted storage device of claim 12, wherein said plurality of tabs are spaced at fixed intervals.

16) The ceiling mounted storage device of claim 12, wherein said lip is perpendicular to said one or more sidewalls.

17) The ceiling mounted storage device of claim 11, wherein said bracket includes a plurality of apertures adapted receive said plurality of fasteners therethrough.

18) The ceiling mounted storage device of claim 11, wherein said plurality of fasteners are toggle bolts.
